(19) United States
(12) Patent Application Publication
(10) Pub. No.: US 2014/0224127 A1
(43) Pub. Date: Aug. 14, 2014

(54) FILTER AND AIR PURIFIER

(71) Applicants: Minoru Nagata, Osaka-shi (JP); Akihiro Yasukawa, Osaka-shi (JP); Yoshiharu Nishino, Ikoma-gun (JP); Tomoaki Okuno, Ikoma-gun (JP)

(72) Inventors: Minoru Nagata, Osaka-shi (JP); Akihiro Yasukawa, Osaka-shi (JP); Yoshiharu Nishino, Ikoma-gun (JP); Tomoaki Okuno, Ikoma-gun (JP)

(73) Assignees: SUMINOE TEXTILE CO., LTD., Osaka-shi, Osaka (JP); SHARP KABUSHIKI KAISHA, Osaka-shi, Osaka (JP)

(21) Appl. No.: 14/349,124

(22) PCT Filed: Sep. 10, 2012
(86) PCT No.: PCT/JP2012/073008

§ 371 Date: Apr. 2, 2014

(30) Foreign Application Priority Data
Oct. 5, 2011 (JP) 2011-221291

(51) Int. Cl. B01D 46/00

(52) U.S. Cl. CPC B01D 46/0036
USPC 96/134; 55/486; 55/467

(57) ABSTRACT

Provided are a space-saving filter that has a plurality of types of air purification capabilities with reduced pressure loss, and a compact air purifier that efficiently exerts a plurality of types of air purification capabilities. Since a body part of a deodorizing filter includes two pieces of deodorizing filter bodies each having the same thickness (hereafter referred to as thickness D) juxtaposed in a plane direction, the body part has the thickness of D. When the deodorizing filter bodies are laminated, the thickness of the body part becomes 2D or more. The body part has a reduced pressure loss and space in a thickness direction compared with a filter in which the deodorizing filter bodies are laminated. The first deodorizing filter body mainly removes aldehyde-based odor components and the second deodorizing filter body mainly removes amine-based odor components. Accordingly, the air purifier including the deodorizing filter has a compact configuration that efficiently exerts the plurality of types of air purification capabilities.

### CROSS-REFERENCE TO RELATED APPLICATIONS

This application is the national phase under 35 U.S.C. §371 of PCT International Application No. PCT/JP2012/73008 which has an International filing date of Sep. 10, 2012 and designated the United States of America.

### FIELD

The present invention relates to a filter that purifies air passing therethrough and an air purifier.

### BACKGROUND

A conventional air purifier includes a blower for blowing air, and a ventilation passage in which a suction port and a blowout port are disposed. Two pieces of filters each of which has a rectangular plate shape are laminated in a vertical orientation around the suction port (see Japanese Patent Application Laid-open No. 2009-066466).

When blowing air by the blower, air is sucked through the suction port from the outside of an apparatus. The sucked air is purified by passing each of two pieces of filters in a thickness direction of the filter, and then blown out through the blowout port to the outside of the apparatus.

Two pieces of filters described in Japanese Patent Application Laid-open No. 2009-066466 are a deodorizing filter and a dust collecting filter.

As the deodorizing filter, there are a filter for mainly removing aldehyde-based odor components and a filter for mainly removing amine-based odor components. However, aldehyde-based odor components and amine-based odor components are included in the odor of tobacco, for example. Therefore, it is preferable that an aldehyde-based deodorizing filter, an amine-based deodorizing filter, and a dust collecting filter are laminated in the ventilation passage of an air purifier.

### SUMMARY

The air passing through the filter loses pressure by friction with the filter. Air pressure loss increases as the number of laminations of the filter increases. When air pressure loss increases, the air flow amount decreases, so the air purification efficiency deteriorates.

Further, as the number of filter laminations increases, the space where the filters are disposed in the ventilation passage should be widened by as much as the thickness of the filters.

For the above reason, an air purifier in which three or more pieces of filters are disposed in lamination has pressure loss greater than an air purifier in which two pieces of filters are disposed in lamination. Therefore, the air purification efficiency is poor. Further, because a space where the filter is to be disposed is wide, it is difficult to design a compact air purifier.

To solve such a problem, reducing the thickness of each filter can be considered. However, there is a limit to reduce the thickness of the filter because of the constraints on the making of the filter, or because of sufficient air purification capability to be maintained.

In consideration of the above-mentioned circumstances, it is an object of the present invention to provide a space-saving filter which is configured in such a way that a plurality of pieces of filter bodies, having two or more types of air purification capabilities, are juxtaposed in a plane direction, whereby providing a plurality of air purification capabilities with reduced pressure loss, and a compact air purifier which efficiently exerts a plurality of types of air purification capabilities.

According to the present invention, there is provided a filter including: a plurality of pieces of filter bodies configured to purify air passing therethrough, wherein at least two filter bodies have different air purification capabilities, and the plurality of pieces of filter bodies are juxtaposed in a plane direction thereof.

In the filter according to the present invention, the plurality of pieces of filter bodies having different air purification capabilities are configured to be different in odor components mainly removed by respective filter bodies.

In the filter according to the present invention, one filter body of the plurality of pieces of filter bodies having different air purification capabilities is made of cellulose and silica gel, and the other filter body thereof is made of cellulose and activated charcoal.

In the filter according to the present invention, a magnitude relation between an area of one filter body configured to mainly remove one odor component and an area of the other filter body configured to mainly remove the other odor component different from the one odor component is inverse to a magnitude relation between a removal rate at which the one odor component is removed by the one filter body and a removal rate at which the other odor component is removed by the other filter body when the respective areas are equal.

In the filter according to the present invention, a magnitude relation between a pressure loss across one filter body configured to mainly remove one odor component and a pressure loss across the other filter body configured to mainly remove the other odor component different from the one odor component is inverse to a magnitude relation between a removal rate at which the one odor component is removed by the one filter body and a removal rate at which the other odor component is removed by the other filter body when the respective pressure losses are equal.

According to the present invention, there is provided an air purifier including: a filter which includes a plurality of pieces of filter bodies configured to purify air passing therethrough; a blower; and a ventilation passage configured to suck air from an outside thereof by blowing air by the blower and blow out the sucked air to the outside thereof after being passed through the filter, wherein the filter is the filter according to the present invention, and the filter is disposed in an orientation crossing to a ventilation direction of the air flowing through the ventilation passage.

In the air purifier according to the present invention, the ventilation direction is a lateral direction, and the plurality of pieces of filter bodies are configured in such a way that ranges having the same air purification capabilities are disposed to be symmetric in a vertical direction or point-symmetric with respect to a central point of the plurality of pieces of filter bodies.

According to the present invention, the filter is configured in such a way that N-pieces of filter bodies are juxtaposed in the plane direction. Herein, N is a natural number of 2 or more (N≧2).

When N-pieces of filter bodies with thickness D (D is a real number greater than 0 (D>0)) are juxtaposed (that is, laminated) in a thickness direction, the thickness of the filter is at least {D×N}. However, when N-pieces of filter bodies are juxtaposed in the plane direction, the thickness of the filter is D. That is, the filter according to the present invention has the thickness reduced to {1/N} or less compared with the filter in which N-pieces of filter bodies are laminated (hereinafter referred to as a laminated filter).

In addition, if the thickness of the laminated filter is D, it is necessary to reduce the thickness of each of N-pieces of filter bodies to at least {D/N}. However, in the filter according to the present invention, it is not necessary to reduce each of N-pieces of filter bodies to less than D.

Meanwhile, in the filter according to the present invention, at least two filter bodies have different air purification capabilities. That is, the filter according to the present invention has at least two types of air purification capabilities.

According to the present invention, n-pieces of filter bodies having different air purification capabilities are different in odor components mainly removed by respective filter bodies. Herein, n is a natural number satisfying 2≦n≦N.

Therefore, the filter according to the present invention may function as a deodorizing filter which removes at least n types of odor components.

According to the present invention, n-pieces of filter bodies having different air purification capabilities include at least a filter body made of cellulose and silica gel, and a filter body made of cellulose and activated charcoal.

Therefore, when the filter body made of cellulose and silica gel mainly removes aldehyde-based odor components and the filter body made of cellulose and activated charcoal mainly removes amine-based odor components, the filter according to the present invention may function as a deodorizing filter which removes the odor of tobacco.

According to the present invention, the magnitude relation between the areas of the filter bodies mainly removing different odor components, is inverse to the magnitude relation between the removal rates when the areas of the respective filter bodies are equal.

For example, when the area of the first filter body that mainly removes the first odor component and the area of the second filter body that mainly removes the second odor component are equal, and if the magnitude relation between the removal rate R1 at which the first filter body removes the first odor component and the removal rate R2 at which the second filter body removes the second odor component is R1≦R2 (or R1≧R2), the magnitude relation between the actual area S1 of the first filter body and the actual area S2 of the second filter body is S1≧S2 (or S1≦S2), wherein R1, R2, S1, and S2 are positive real numbers, respectively.

As a result of the above, the area of the filter body for which it is difficult to remove odor components, is wider than the area of the filter body for which it is easy to remove odor components. Therefore, a lot of air comes into contact with the filter body for which it is difficult to remove odor components, compared with the filter body for which it is easy to remove odor components.

Therefore, in the filter according to the present invention, the removal rate of the first odor component and the removal rate of the second odor component are at the same level. In other words, the filter according to the present invention may remove many types of odor components uniformly from the air passing therethrough.

According to the present invention, the magnitude relation between the pressure losses across the filter bodies mainly removing different odor components is inverse to the magnitude relation between the removal rates when the pressure losses across the respective filter bodies are equal.

For example, when the pressure loss across the first filter body that mainly removes the first odor component and the pressure loss across the second filter body that mainly removes the second odor component are equal, and if the magnitude relation between the removal rate E1 at which the first filter body removes the first odor component and the removal rate E2 at which the second filter body removes the second odor component is E1≦E2 (or E1≧E2), the magnitude relation between the actual pressure loss L1 across the first filter body and the actual pressure loss L2 across the second filter body is L1≧L2 (or L1≦L2), wherein E1, E2, L1, and L2 are positive real numbers, respectively.

As a result of the above, an air permeability of the filter body for which it is difficult to remove odor components is lower than that of the filter body for which it is easy to remove odor components. Therefore, a wind speed, at which air passes through the filter body, of the filter body for which it is difficult to remove odor components is low, compared with the filter body for which it is easy to remove odor components. That is, air comes into contact with the filter body for which it is difficult to remove odor components for a long time, compared with the filter body for which it is easy to remove odor components.

Therefore, in the filter according to the present invention, the removal rate of the first odor component and the removal rate of the second odor component are at the same level. In other words, the filter according to the present invention may remove many types of odor components uniformly from the air passing therethrough.

According to the present invention, the air purifier includes the filter according to the present invention, a blower, and a ventilation passage.

The filter according to the present invention is disposed in an orientation crossing to the ventilation direction of the air flowing through the ventilation passage. In other words, the ventilation direction is a direction crossing to the filter (for example, a thickness direction thereof).

If the ventilation direction is a direction along the filter (for example, the plane direction thereof), it is necessary to increase the dimension of the space for disposing the filter in the ventilation direction to a greater extent than the filter thickness D, compared with the case in which the ventilation direction is a direction crossing to the filter. That is, in the air purifier according to the present invention, the dimension of the space for disposing the filter in the ventilation direction is reduced to the same size as the thickness D of the filter.

According to the present invention, the ventilation direction is the lateral direction (for example, forward, rearward, left, or right direction, etc). Therefore, the filter according to the present invention is disposed in a vertical orientation. Further, the plurality of pieces of filter bodies are configured in such a way that ranges having the same air purification capabilities are disposed to be symmetric in a vertical direction (that is, top-bottom symmetry) or point-symmetric with respect to a central point of the plurality of pieces of filter bodies.

Therefore, the type of air purification capability achieved by the filter body disposed in the upper half inside the ventilation passage, and the type of air purification capability achieved by the filter body, disposed in the lower half inside the ventilation passage, are equal.

When the ventilation direction is the lateral direction, the air flow rate of the upper half inside the ventilation passage, is smaller than the air flow rate of the lower half. Therefore, air is efficiently purified in the part with a high flow rate, and it is difficult for the air to be purified in the part with a low flow rate.

However, in the air purifier according to the present invention, there are no particular problems since the same type of air purification capabilities are achieved in the upper half and the lower half of the ventilation passage.

If the plurality of pieces of filter bodies are disposed to be symmetric in the lateral direction (that is, in front-back symmetry or left-right symmetry), there is a possibility that the type of air purification capability achieved by the filter body disposed in the upper half inside the ventilation passage, and the type of air purification capability achieved by the filter body disposed in the lower half inside the ventilation passage, could be different. Therefore, the air purification capability that is exerted efficiently, and air purification capability that is difficult to be exerted, arise.

According to the present invention, since the plurality of pieces of filter bodies have different air purification capabilities, the filter according to the present invention may have a plurality of types of air purification capabilities.

Further, since the plurality of pieces of filter bodies are juxtaposed in the plane direction, the thickness of the filter may be reduced compared with the laminated filter. Therefore, the filter according to the present invention may reduce the air pressure loss compared with the laminated filter. Further, the filter according to the present invention is a filter with reduced space in the thickness direction compared with the laminated filter.

Further, each filter body may have a necessary and sufficient thickness depending on the constraints at the time of manufacture or the conditions such as the desired extent of air purification capability.

The air purifier of the present invention includes the filter according to the present invention which has a plurality of types of air purification capabilities and a reduced pressure loss, so that it is possible to improve the air purification efficiency as well as exert the plurality of types of air purification capabilities.

Further, the filter of the present invention is thin and the ventilation direction is a direction crossing to the filter of the present invention. Therefore, the air purifier of the present invention may have a compact configuration in the ventilation direction.

The above and further objects and features will more fully be apparent from the following detailed description with accompanying drawings.

### BRIEF DESCRIPTION OF THE DRAWINGS

FIG. 1 is a perspective view illustrating an outer appearance of an air purifier according to Embodiment 1 of the present invention as seen from a front side thereof.

FIG. 2 is a perspective view illustrating the outer appearance of the air purifier according to Embodiment 1 of the present invention as seen from a rear side thereof.

FIG. 3 is a cross-sectional side view schematically illustrating major parts of the air purifier according to Embodiment 1 of the present invention.

FIG. 4 is a rear view illustrating a configuration of a deodorizing filter according to Embodiment 1 of the present invention.

FIG. 5 is an enlarged rear view illustrating the configuration of the deodorizing filter according to Embodiment 1 of the present invention.

FIG. 6 is a table illustrating deodorization performance test results of the air purifier according to Embodiment 1 of the present invention.

FIG. 7 is a rear view illustrating another configuration of the deodorizing filter according to Embodiment 1 of the present invention.

FIG. 8 is a rear view illustrating a configuration of a deodorizing filter according to Embodiment 2 of the present invention.

FIG. 9 is a rear view illustrating another configuration of the deodorizing filter according to Embodiment 2 of the present invention.

FIG. 10 is a rear view illustrating a configuration of a deodorizing filter according to Embodiment 3 of the present invention.

FIG. 11 is an enlarged rear view illustrating a configuration of a deodorizing filter according to Embodiment 4 of the present invention.

FIG. 12 is an enlarged rear view illustrating another configuration of the deodorizing filter according to Embodiment 4 of the present invention.

FIG. 13 is a cross-sectional side view schematically illustrating major parts of a garbage disposer including a deodorizing filter according to Embodiment 5 of the present invention.

### DETAILED DESCRIPTION

Hereinafter, the present invention will be described in detail with reference to the accompanying drawings illustrating the embodiments thereof.

### Embodiment 1

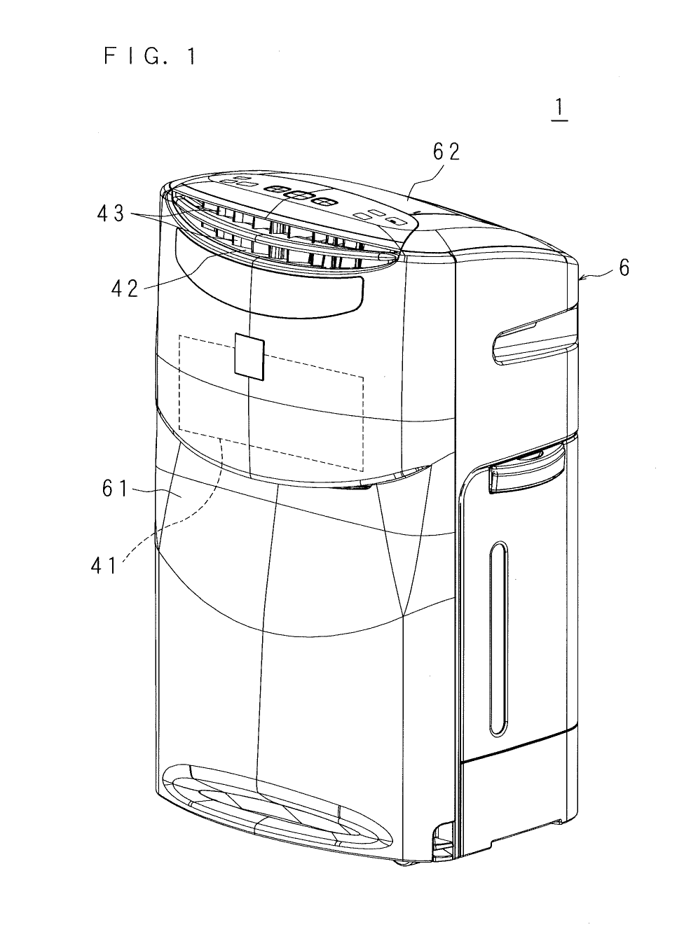

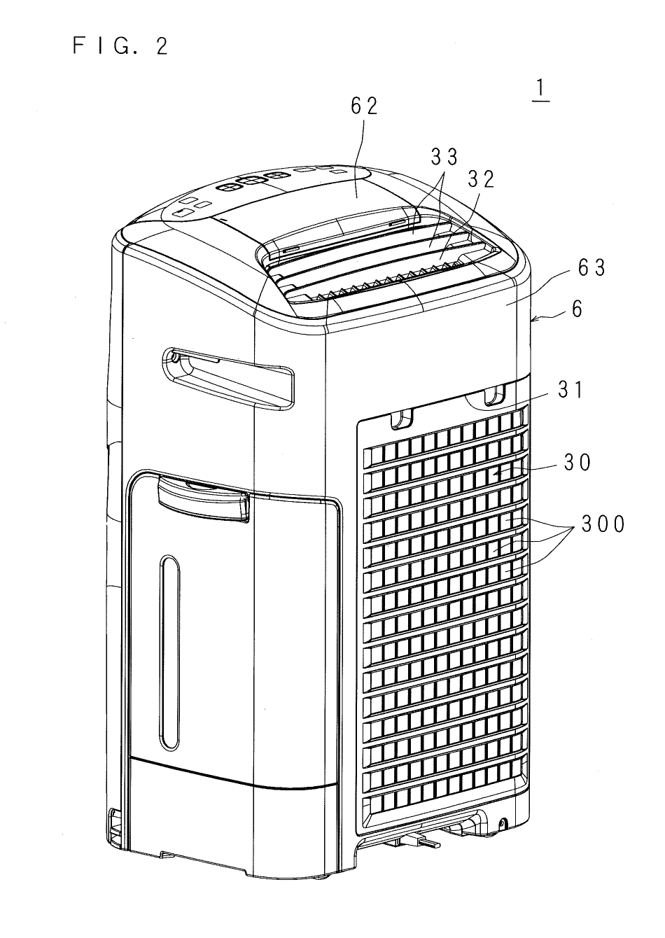

FIGS. 1 and 2 are perspective views illustrating an outer appearance of an air purifier 1 according to Embodiment 1 of the present invention. FIG. 1 is a view illustrating the air purifier 1 as seen from a front side thereof, and FIG. 2 is a view as seen from a rear side thereof.

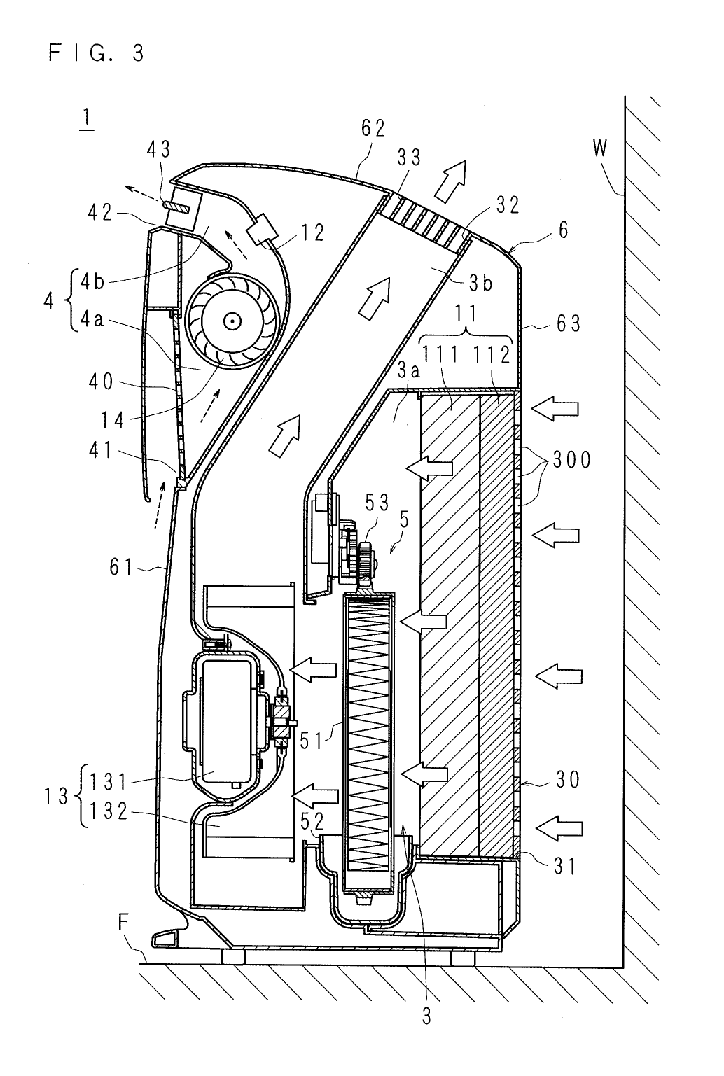

FIG. 3 is a cross-sectional side view schematically illustrating major parts of the air purifier 1.

A left side (and a right side) in FIG. 3 is a front side (and a back side) of the air purifier 1. Hereinafter, the left side (and the right side) in FIG. 3 refers to the front side (and the back side) of the air purifier 1. A direction perpendicular to the paper surface in FIG. 3, is a horizontal direction of the air purifier 1.

The air purifier 1 of the present embodiment has an air purifying function by deodorizing and dust collecting, and an air purifying function by a positive ion and negative ion (hereinafter referred to as positive and negative ions), and air humidifying function.

First, a substantial configuration of the air purifier 1 will be described with reference to FIGS. 1 to 3.

The air purifier 1 includes a housing 6 of a vertical rectangular shape. The housing 6 has a front cover 61, a top face cover 62, and a rear cover 63 and the like.

In a room having a wall W and a floor F, the air purifier 1 is placed on the floor F in an orientation in which the rear cover 63 of the housing 6 faces the wall W.

The housing 6 is provided with a first ventilation passage 3 for achieving the air humidifying function and an air purifying function by deodorizing and dust collecting, and a second ventilation passage 4 for achieving the air purifying function by positive and negative ions. The first ventilation passage 3 and the second ventilation passage 4 are separated from each other.

Next, the first ventilation passage 3 will be described with reference to FIGS. 2 and 3.

The first ventilation passage 3 has a filter storage section 3a and a blowout passage 3b which are communicated with each other in this order. Further, the first ventilation passage 3 is provided with a first suction port 31 and a first blowout port 32.

The first suction port 31 is opened in the rear cover 63 of the housing 6, so that an outside of the air purifier 1 and the filter storage section 3a are communicated through the first suction port 31. The first blowout port 32 is opened in the top face cover 62 of the housing 6, so that the blowout passage 3b and the outside of the air purifier 1 are communicated through the first blowout port 32.

When blowing air by a first blower 13, to be described below, air outside of the air purifier 1 is sucked into the first ventilation passage 3 through the first suction port 31. The sucked air flows through the filter storage section 3a and the blowout passage 3b in this order, and then is blown out to the outside of the air purifier 1 through the first blowout port 32.

A rear panel 30 is detachably attached to the housing 6 so as to close the first suction port 31. Herein, a plurality of vent holes 300, 300, and . . . are formed in the rear panel 30. Therefore, the air flowing through the first suction port 31 more specifically means the air flowing through the vent holes 300, 300, and . . . . The vent holes 300, 300, and . . . are closed by a pre-filter (not shown). The pre-filter collects and removes coarse dust contained in the air flowing into the filter storage section 3a through the first suction port 31.

An air purification chamber is provided near the first suction port 31 of the filter storage section 3a (in more detail, in the front of the rear panel 30), and an air purification unit 11 is housed in the air purification chamber. Air flowing into the filter storage section 3a through the first suction port 31 passes through the air purification unit 11. A rated air volume relating to the air purification unit 11 is 6.5 CMM (cubic meter per minute), for example.

The air passing through the air purification unit 11 is purified. For this, the air purification unit 11 is provided with a dust collecting filter 111 and a deodorizing filter 112, each of which has a rectangular plate shape.

The dust collecting filter 111 is, for example, a publicly known high efficiency particulate air HEPA filter which collects and removes fine dust, pollen, or the like contained in the air passing through the dust collecting filter 111, by static electricity. The dust collecting filter 111 includes a dust collecting filter body of a rectangular plate shape, and a frame for holding the dust collecting filter.

The deodorizing filter 112 removes odor components contained in the air passing through the deodorizing filter 112. A detailed configuration of the deodorizing filter 112 will be described below.

A vertical length (hereinafter referred to as a height) and a horizontal length (hereinafter referred to as a width) of the respective dust collecting filter 111 and the deodorizing filter 112 are the same as each other, but a longitudinal length (hereinafter referred to a thickness) of the deodorizing filter 112 is smaller than that of the dust collecting filter 111.

Herein, the air flowing into the filter storage section 3a through the first suction port 31 flows through the filter storage section 3a in a forward direction. That is, the ventilation direction in the air purification chamber of the filter storage section 3a is a lateral direction.

The dust collecting filter 111 and the deodorizing filter 112 are laminated in the air purification unit of the filter storage section 3a. At this time, each of the dust collecting filter 111 and the deodorizing filter 112 is disposed in a vertical orientation in the horizontal direction. Therefore, the plane direction of the dust collecting filter 111 and the deodorizing filter 112 is a direction crossing to the ventilation direction.

The air purification unit 11 is disposed vertically in FIG. 3. In other words, the air purification unit 11 is orthogonal to the ventilation direction. However, the air purification unit 11 may be disposed in a forward inclined orientation which is inclined appropriately forward. In this case, when a user removes the rear panel 30, a problem in which the air purification unit 11 falls over backward freely, then drops out unnecessarily from the housing 6 is suppressed.

In addition, among the dust collecting filter 111 and the deodorizing filter 112, the deodorizing filter 112 is located on the first suction port 31 side (i.e. an upstream side in the ventilation direction), as illustrated in FIG. 3. Therefore, the contamination of the dust collecting filter 111 by the offensive odor is suppressed in comparison with the case where the dust collecting filter 111 is located on the upstream side in the ventilation direction. In this regard, the deodorizing filter 112 is easily contaminated due to the dust, pollen, or the like adhered thereto. However, the user can easily remove the adhered dust, pollen, or the like from the deodorizing filter 112 by air suction so that it does not become a major problem regarding the contamination thereof.

A humidification filter unit 5 is disposed in the filter storage section 3a between the air purification unit 11 and the first blower 13.

The humidification filter unit 5 is provided with a humidification filter 51, a water reception tray 52, and a rotation driving mechanism 53.

The humidification filter 51 is formed in a disc shape, and includes a humidification filter body having water absorbability and air permeability, and a frame for holding the humidification filter body. In addition, the humidification filter 51 is disposed in a vertical orientation, and a portion in a circumferential direction thereof immerses and absorbs water in the water reception tray 52.

Water at a constant level is stored in the water reception tray 52. For this, water is supplied into the water reception tray 52 from a water supply tank (not shown) having a built-in publicly known constant water level valve.

The rotation driving mechanism 53 rotates the humidification filter 51 in the circumferential direction thereof. At this time, a peripheral portion of the humidification filter 51 continuously immerses and absorbs water in the circumferential direction, and further sucks water from the peripheral portion to a central portion thereof. From the above result, water stored in the water reception tray 52 is efficiently spread over the whole of the humidification filter 51.

Air passing through the air purification unit 11 passes through the humidification filter 51. When the humidification filter 51 is rotating, air passing through the humidification filter 51 sufficiently absorbs moisture. On the other hand, when the humidification filter 51 is not rotating, air passing through the humidification filter 51 does not absorb moisture almost. Therefore, when the air purifier 1 performs air purification as well as air humidification, the rotation driving mechanism 53 is operated to rotate the humidification filter 51. On the other hand, when the air purifier performs only the air purification without performing air humidification, the rotation driving mechanism 53 is not operated. Hereinafter, a case in which the air purifier 1 performs the air purification as well as air humidification will be described.

The first blower 13 is disposed at a boundary portion between the filter storage section 3a and the blowout passage 3b.

The first blower 13 uses a sirocco fan (a multi-blade impeller), and includes an electric fan motor 131, and a fan 132.

The fan motor 131 uses a DC motor, and is fixed to the inside of the housing 6 by a support (not shown).

The fan 132 is fixed to an output shaft of the fan motor 131. When the fan 132 is rotated by driving the fan motor 131, the fan 132 is also rotated to blow out air.

Air flows substantially horizontally forward from the rear side in the filter storage section 3a, and air flows from a front lower side to a rear upper side at a slant in the blowout passage 3b.

A louver 33 is disposed in the first blowout port 32. The louver 33 controls an air flowing direction with an inner peripheral surface of the blowout passage 3b, such that air blowing through the first blowout port 32 is easily raised along the wall W.

In the first ventilation passage 3 having the above-described configuration, the air flows along solid line hollow arrows by the blowing of the first blower 13.

More specifically, air is sucked into the filter storage section 3a through the first suction port 31 from a room. The sucked air flows through the filter storage section 3a in the forward direction. At this time, the sucked air is purified and humidified by passing through the air purification unit 11 and the humidification filter 51. Hereinafter, the air that has been purified and humidified by the air purification unit 11 and the humidification filter 51 is referred to as purified and humidified air.

Subsequently, the purified and humidified air flows from the filter storage section 3a to the blowout passage 3b. In the blowout passage 3b, the purified and humidified air flows to the rear upward direction, and finally, is blown into the room through the first blowout port 32.

The purified and humidified air blown into the room is sprayed onto the wall W, raised along the wall W, moved to a wall facing the wall W along the ceiling, moved down along this wall, and then moved to the wall W along the floor F. In other words, the purified and humidified air is circulated around in the entire room.

Next, the second ventilation passage 4 will be described with reference to FIGS. 1 and 3.

The second ventilation passage 4 has a suction chamber 4a and a blowout chamber 4b which are communicated with each other. The second ventilation passage 4 is provided with a second suction port 41 and a second blowout port 42.

The second suction port 41 is opened in the front cover 61 of the housing 6, so that the outside of the air purifier 1 and the suction chamber 4a are communicated through the second suction port 41.

The second blowout port 42 is opened at a boundary portion between the front cover 61 and the top face cover 62 of the housing 6, so that the blowout chamber 4b and the outside of the air purifier 1 are communicated through the second blowout port 42.

When blowing air by a second blower 14 to be described below, air outside of the air purifier 1 is sucked into the second ventilation passage 4 through the second suction port 41. The sucked air flows through the suction chamber 4a and the blowout chamber 4b in this order, and then is blown out to the outside of the air purifier 1 through the second blowout port 42.

An air filter 40 is detachably disposed in the second suction port 41. The air filter 40 collects and removes coarse dust contained in the air flowing into the suction chamber 4a through the second suction port 41. A size of dust removed by the air filter 40 and the size of dust removed by the pre-filter of the rear panel 30 are at the same level.

The second blower 14 is disposed at the boundary portion between the suction chamber 4a and the blowout chamber 4b.

The second blower 14 employs a cross-flow fan (a cross-flow impeller), and includes an electric fan motor which is fixed inside of the housing 6 by a support (not shown), and a fan which is fixed to an output shaft of the fan motor. When the second blower 14 is rotated by driving the fan motor, the fan is also rotated to blow out air.

An ion generator 12 is disposed in the middle of the blowout chamber 4b.

The ion generator 12 includes an ion generating electrode (not shown), and a counter electrode which is disposed to face the ion generating electrode, such that positive and negative ions are generated by corona discharge. The ion generating electrode is exposed to the blowout chamber 4b, and the generated positive and negative ions float in the air flowing through the blowout chamber 4b.

Air flows from the front lower side to the rear upper side at a slant in the suction chamber 4a, and air flows to the front upper side therefrom at a slant in the blowout chamber 4b.

A louver 43 is disposed in the second blowout port 42. The louver 43 controls an air flowing direction with an inner peripheral surface of the blowout chamber 4b, such that air blowing through the second blowout port 42 easily reaches a central portion of the room.

Positive and negative ions released into the room with the air blown through the second blowout port 42 kill and inactivate fungi, viruses, allergens, or the like, and decompose substances (for example, organic compounds such as acetaldehyde) causing offensive odors.

In the second ventilation passage 4 having the above-described configuration, the air flows along dashed arrows by the blowing of the second blower 14.

More specifically, air is sucked into the suction chamber 4a through the second suction port 41 from the room. The sucked air flows through the suction chamber 4a in the rear upper direction, and then flows through the blowout chamber 4b in the front upper direction. The air flowing through the blowout chamber 4b becomes air which contains ions (hereinafter referred to as ion containing air) generated by the ion generator 12. Further, the ion containing air is blown into the room through the second blowout port 42.

The ion-containing air blown into the room moves toward the central portion of the room. As a result, the ion containing air easily reaches the central portion of the room.

Subsequently, the constitution of the deodorizing filter 112 will be described in detail.

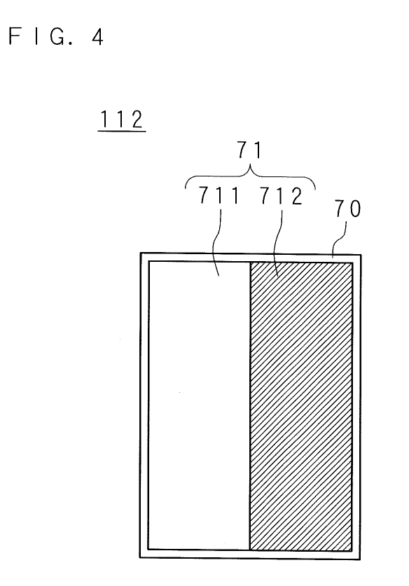

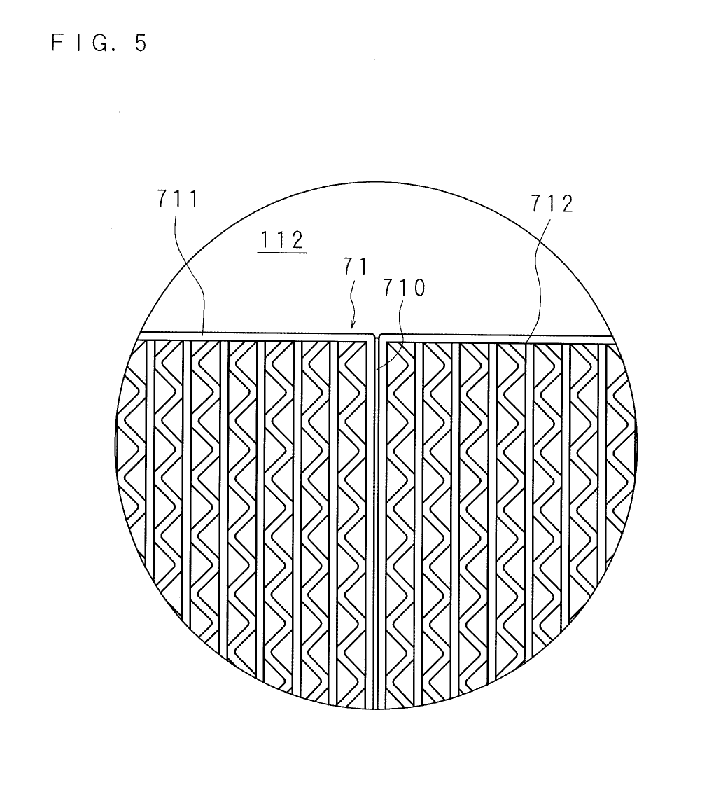

FIGS. 4 and 5 are a rear view and an enlarged rear view illustrating a configuration of the deodorizing filter 112, respectively. A frame 70, to be described below, is not illustrated in FIG. 5.

The deodorizing filter 112 includes a body part 71 of a rectangular plate shape, and the frame 70 for holding the body part 71.

The body part 71 is provided with two deodorizing filter bodies 711 and 712, each of which has a rectangular plate shape. Each of the deodorizing filter bodies 711 and 712 has a honeycomb structure of a corrugated type (one honeycomb layer). The height, width, and thickness D of the respective deodorizing filter bodies 711 and 712 are the same as each other. Further, the pressure loss across the respective deodorizing filter bodies 711 and 712 are the same as each other.

The body part 71 is formed by juxtaposing the deodorizing filter bodies 711 and 712 in the plane direction. Specifically, a left half (a range shown by white in FIG. 4) of the body part 71 includes a first deodorizing filter body 711, and a right half (a range shown by hatching in FIG. 4) of the body part 71 includes a second deodorizing filter body 712. Accordingly, the height and thickness D of the respective deodorizing filter bodies 711 and 712, are the same as the height and thickness D of the body part 71, but the width of the respective deodorizing filter bodies 711 and 712, is a half {½} of the width of the body part 71.

The right side portion of the first deodorizing filter body 711 and the left side portion of the second deodorizing filter body 712 are bonded through an adhesive layer 710 made of an EVA-based synthetic resin. In other words, the deodorizing filter bodies 711 and 712 are bonded by juxtaposing the same in the horizontal direction (that is, the lateral direction).

Each of the deodorizing filter bodies 711 and 712 purifies the air passing therethrough, but the deodorizing filter bodies 711 and 712 have different air purification capabilities.

Specifically, the first deodorizing filter body 711 mainly removes, by adsorbing and decomposing, aldehyde-based odor components (acetaldehyde (CH₃ CHO) and acetic acid (CH₃ COOH), etc.). Such a first deodorizing filter body 711 is made of cellulose and silica gel.

Herein, an example of a manufacturing process of the first deodorizing filter body 711 will be described. First, a manufacturer prepares a block body having the honeycomb structure using a flute (a corrugated plate-shaped sheet) member and a liner (a plate plate-shaped sheet) member, which are made of silica gel mixed with paper. Then, the manufacturer cuts the prepared block body in a predetermined height, width, and thickness D to form the first deodorizing filter body 711.

Moreover, it is preferable that the first deodorizing filter body 711 employs a filter as described in Japanese Patent Application Laid-open No. 2009-148402.

On the other hand, the second deodorizing filter body 712 mainly removes, by adsorbing and decomposing, amine-based odor components (for example, ammonia (NH₃)). Such a second deodorizing filter body 712 is made of cellulose and activated charcoal.

Herein, an example of a manufacturing process of the second deodorizing filter body 712 will be described. First, a manufacturer prepares a block body having the honeycomb structure using a flute member and a liner member, which are made of activated charcoal paper. Then, the manufacturer cuts the prepared block body in a predetermined height, width, and thickness D to form the second deodorizing filter body 712.

Moreover, it is preferable that the second deodorizing filter body 712 employs a filter as described in Japanese Patent Application Laid-open No. 2011-123315.

As described above, the ventilation direction in the air purification chamber of the filter storage section 3a is the lateral direction. Therefore, the air flow rate in the upper half of the air purification chamber is less than that of the lower half. Therefore, the volume of air spraying to the upper half of the deodorizing filter 112 is less than the volume of air spraying to the lower half.

However, the body part 71 of the deodorizing filter 112 is configured in such a way that the ranges having the same air purification capabilities (specifically, the range in which the aldehyde-based odor components are mainly removed, or the range in which amine-based odor components are mainly removed) are disposed to be top-bottom symmetric (that is, symmetric in the vertical direction).

Therefore, the air flow amount of the upper half (or the lower half) of the first deodorizing filter body 711 and the air flow amount of the upper half (or the lower half) of the second deodorizing filter body 712 are substantially equal. In other words, the air flow amount of the whole of the first deodorizing filter body 711 and the air flow amount of the whole of the second deodorizing filter body 712 are substantially equal. Accordingly, both the removal of aldehyde-based odor components by the first deodorizing filter body 711 and the removal of amine-based odor components by the second deodorizing filter body 712 are efficiently performed.

If the respective air flow amounts of the deodorizing filter bodies 711 and 712 are different, the odor components to be removed by the filter body with high air flow amount can be removed efficiently, but the odor components to be removed by the filter body with low air flow amount cannot be removed efficiently.

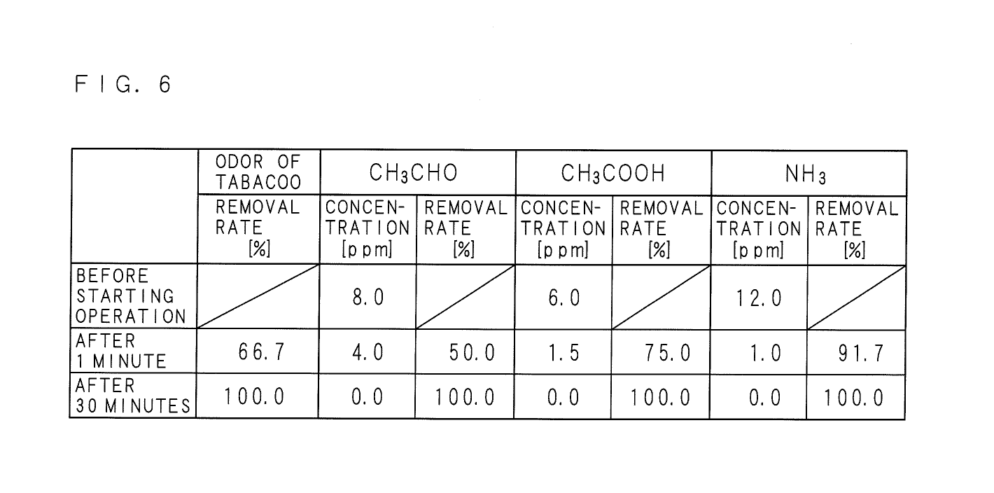

FIG. 6 is a table illustrating deodorization performance test results of the air purifier 1.

The present inventors performed a deodorizing performance test based on JEMA1467 using the air purifier 1. In this deodorizing performance test, the present inventors burned five cigarettes in a 1 m³ box, and operated the air purifier 1 placed in the box at a rated air volume. In addition, the concentration of each odor component was measured and the removal rate of each odor component was obtained based on the measured value.

Herein, when the concentration of the odor component before starting operation of the air purifier 1 is Cb and the concentration after starting operation is Ca, then the removal rate is represented by the equation below.

Removal rate={Cb−Ca}/Cb×100.

Acetaldehyde, acetic acid, and ammonia are included in the odor of tobacco, as an odor component.

The concentration [ppm] of each odor component measured before starting operation of the air purifier 1, acetaldehyde was 8.0 ppm, acetic acid was 6.0 ppm, and ammonia was 12.0 ppm.

After starting operation of the air purifier 1, the concentration [ppm] of each odor component measured when one minute had elapsed, acetaldehyde was 4.0 ppm, acetic acid was 1.5 ppm, and ammonia was 1.0 ppm, and removal rate thereof was 50.0%, 75.0%, and 91.7%, respectively. Further, the removal rate of the odor of tobacco was 66.7%.

As described above, the air purifier 1 of the present embodiment is not able to completely remove the odor of tobacco in one minute. It is considered that, by operating the air purifier 1 for a short time, because the air containing the odor of tobacco did not pass the deodorizing filter 112 at all, the number of times that air passed through the deodorizing filter 112 was less, or the air passed through only one of the deodorizing filter bodies 711 and 712.

After starting operation of the air purifier 1, the concentration [ppm] of the odor components when 30 minutes had elapsed, all were 0.0 ppm, and the removal rate was 100%. Further, the removal rate of the odor of tobacco was 100.0%.

As described above, the air purifier 1 of the present embodiment can entirely remove the odor of tobacco in 30 minutes. It is considered that this is because the air containing the odor of tobacco passed through many times both of the deodorizing filter bodies 711 and 712.

Then, in general, the user of the air purifier 1 continuously operates the air purifier 1 for at least several tens of minutes.

From the above description, it may be said that the air purifier 1 has a sufficient deodorizing performance.

Next, the reasons why the deodorizing filter bodies 711 and 712 are juxtaposed in the plane direction will be described.

Each of the deodorizing filter bodies 711 and 712 is formed by cutting the block body having the honeycomb structure. Therefore, there is a limit to reduce the thickness D of the respective deodorizing filter bodies 711 and 712. For example, the lower limit of the thickness D thereof is 8 mm.

Accordingly, when the deodorizing filter bodies 711 and 712 are juxtaposed (that is, laminated) in a thickness direction thereof, the thickness of the body part 71 will be at least two times (hereinafter referred as thickness 2D) of the thickness D. Therefore, it is impossible to make the thickness of the body part 71 less than 16 mm.

On the other hand, when the deodorizing filter bodies 711 and 712 are juxtaposed in the plane direction thereof, the thickness of the body part 71 is the thickness D. Therefore, it is possible to make the thickness of the body part 71a minimum of 8 mm.

The pressure loss across the body part 71 with the thickness of 2D is greater than the pressure loss across the body part 71 with the thickness D. Because increase in pressure loss leads to reduction in blast volume, the air purifying efficiency is deteriorated.

In addition, the deodorizing filter 112 including the body part 71 with the thickness of 2D is thicker than the deodorizing filter 112 including the body part 71 with the thickness of D. Therefore, the deodorizing filter 112 including the body part 71 with the thickness of 2D may not be stored in the air purifying chamber of the filter storage section 3a with the dust collecting filter 111.

In order to store the deodorizing filter 112 including the body part 71 with the thickness of 2D, it is necessary either to reduce the thickness of the dust collecting filter 111, or increase the dimension of the air purification chamber in the ventilation direction. However, if the thickness of the dust collecting filter 111 is reduced, dust collecting performance of the dust collecting filter 111 may be decreased. Further, in order to change the dimension of the air purification chamber, a design change such as an increase of the housing 6, a decrease of the humidification filter unit 5, or the like may be necessary.

From the above description, in the body part 71, the configuration in which the deodorizing filter bodies 711 and 712 are juxtaposed in the plane direction has an advantage over the configuration in which they are juxtaposed in the thickness direction.

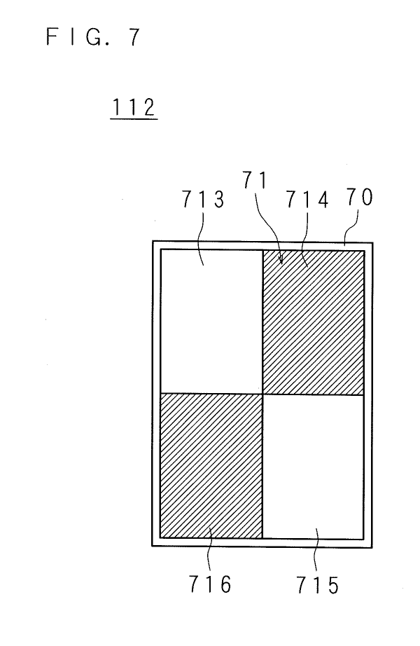

FIG. 7 is a rear view illustrating another configuration of the deodorizing filter 112.

The body part 71 of the deodorizing filter 112 illustrated in FIG. 7 includes four pieces of deodorizing filter bodies 713, 714, 715 and 716 (hereinafter referred to as deodorizing filter bodies 713 to 716), each of which has a rectangular shape. The height, width, and thickness D of the respective deodorizing filter bodies 713 to 716 are the same as one another. Further, the pressure loss across the respective deodorizing filter bodies 713 to 716 are the same as one another.

The body part 71 is formed by juxtaposing the deodorizing filter bodies 713 to 716 in a zigzag in the plane direction. Specifically, the left upper half and the right lower half of the body part 71 include first deodorizing filter bodies 713 and 715 (parts shown by white in FIG. 7). In addition, the right upper half and the left lower half of the body part 71 include second deodorizing filter bodies 714 and 716 (parts shown by hatching in FIG. 7). Accordingly, the thickness D of the respective deodorizing filter bodies 713 to 716 is equal to the thickness of the body part 71, but the height and width of the respective deodorizing filter bodies 713 to 716 are a half {½} of the height and width of the body part 71.

Each of the deodorizing filter bodies 713 to 716 is bonded to the other adjacent deodorizing filter bodies through adhesive layers made of an EVA-based synthetic resin. In other words, the deodorizing filter bodies 713 to 716 are bonded by juxtaposing the same in the vertical and horizontal directions.

That is, the body part 71 of the deodorizing filter 112 illustrated in FIG. 4 is configured in such a way that the ranges having the same air purification capabilities are disposed to be symmetric in the vertical direction, but the body part 71 of the deodorizing filter 112 illustrated in FIG. 7 is configured in such a way that the ranges having the same air purification capabilities are disposed to be point-symmetric with respect to a central point of the body part 71.

Therefore, the air flow amount of the first deodorizing filter body 713 (or the first deodorizing filter body 715) and the air flow amount of the second deodorizing filter body 714 (or the second deodorizing filter body 716) are substantially equal. In other words, the air flow amount of the whole of the first deodorizing filter bodies 713 and 715 and the air flow amount of the whole of the second deodorizing filter bodies 714 and 716 are substantially equal. Accordingly, both the removal of aldehyde-based odor components by the first deodorizing filter bodies 713 and 715 and the removal of amine-based odor components by the second deodorizing filter bodies 714 and 716 are efficiently performed.

As describe above, although the configurations of the deodorizing filter 112 illustrated in FIG. 4 and the deodorizing filter 112 illustrated in FIG. 7 are different from each other, the deodorization performance of the air purifier 1 including the deodorizing filter 112 illustrated in FIG. 4 and the deodorization performance of the air purifier 1 including the deodorizing filter 112 illustrated in FIG. 7 are at the same level.

### Embodiment 2

An air purifier 1 of the present embodiment has the same configuration as the air purifier 1 of the Embodiment 1 except the configuration of a deodorizing filter 112. Hereinafter, the deodorizing filter 112 of the present embodiment will be described, and the other parts corresponding to the Embodiment 1 will be denoted by the same reference numerals, and a detailed description thereof will be omitted.

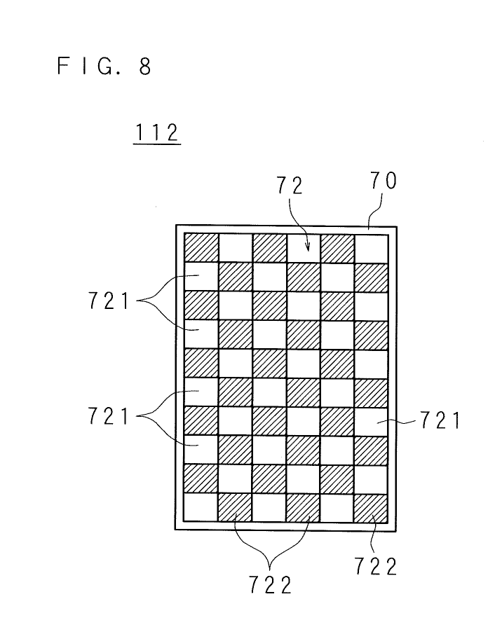

FIG. 8 is a rear view illustrating the configuration of the deodorizing filter 112 according to Embodiment 2 of the present invention.

The deodorizing filter 112 illustrated in FIG. 8 includes a body part 72 instead of the body part 71 of the Embodiment 1.

The body part 72 is configured by juxtaposing thirty pieces of first deodorizing filter bodies 721, 721 and . . . , each of which has a rectangular plate shape and thirty pieces of second deodorizing filter bodies 722, 722 and . . . , each of which has a rectangular shape in a zigzag in the plane direction. The height, width, and thickness D of the respective deodorizing filter bodies 721, 721 and . . . , and 722, 722 and . . . are equal. In addition, the pressure loss across the respective deodorizing filter bodies 721, 721 and . . . , and 722, 722 and . . . is equal.

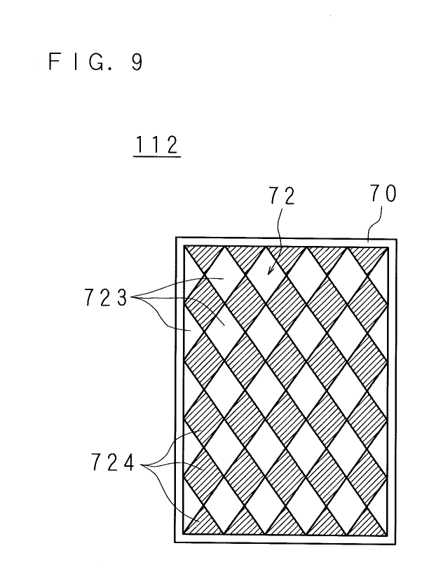

FIG. 9 is a rear view illustrating another configuration of the deodorizing filter 112 according to Embodiment 2 of the present invention.

The body part 72 provided in the deodorizing filter 112 illustrated in FIG. 9 is configured by juxtaposing thirty pieces of first deodorizing filter bodies 723, 723 and . . . , each of which has a diamond plate shape and thirty pieces of second deodorizing filter bodies 724, 724 and . . . , each of which has a diamond plate shape in a zigzag in the plane direction. The height, width, and thickness D of the respective deodorizing filter bodies 723, 723 and . . . ; and 724, 724 and . . . are equal. However, since the body part 72 has the rectangular shape, ten pieces of the first deodorizing filter bodies 723, 723 and . . . form a shape corresponding to a vertical half of the diamond shape, and ten pieces of the second deodorizing filter bodies 724, 724 and . . . form a shape corresponding to a lateral half of the diamond shape. In addition, the pressure loss across the respective deodorizing filter bodies 723, 723 and . . . ; and 724, 724 and . . . is equal.

According to the deodorizing filter 112 having the above-described configuration illustrated in FIGS. 8 and 9, the body part 72 has improved design properties. Moreover, the deodorization performance of the air purifier 1 including the deodorizing filter 112 is at the same level with the air purifier 1 of Embodiment 1.

### Embodiment 3

An air purifier 1 of the present embodiment has the same configuration with the air purifier 1 of the Embodiments 1 and 2 except the configuration of a deodorizing filter 112. Hereinafter, the deodorizing filter 112 of the present embodiment will be described, and the other parts corresponding to the Embodiment 1 will be denoted by the same reference numerals, and a detailed description thereof will be omitted.

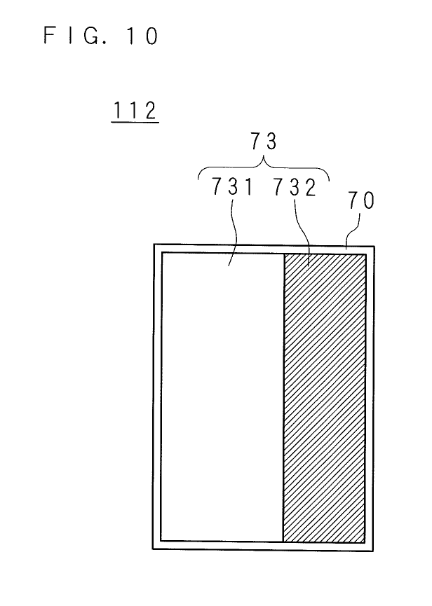

FIG. 10 is a rear view illustrating the configuration of the deodorizing filter 112 according to Embodiment 3 of the present invention. FIG. 10 corresponds to FIG. 4 of Embodiment 1.

The deodorizing filter 112 illustrated in FIG. 10 includes a body part 73 instead of the body parts 71 and 72 of Embodiments 1 and 2.

The body part 73 includes two pieces of deodorizing filter bodies 731 and 732, each of which has a rectangular shape. Each of the deodorizing filter bodies 731 and 732 has a honeycomb structure of a corrugated shape. The height and thickness D of the respective deodorizing filter bodies 731 and 732 are equal. In addition, the pressure loss across the respective deodorizing filter bodies 731 and 732 is equal.

The width of a first deodorizing filter body 731 is 1.5 times the width of a second deodorizing filter body 732. Accordingly, the width ratio and therefore the area ratio of the deodorizing filter bodies 731 and 732 is 3:2.

The body part 73 is configured by juxtaposing the deodorizing filter bodies 731 and 732 on the left and right in the plane direction. Specifically, a range of {⅗} from the left of the body part 73 (a part illustrated by white in FIG. 10) includes the first deodorizing filter body 731, and a range of {⅖} from the right of the body part 73 (a part illustrated by hatching in FIG. 10) includes the second deodorizing filter body 732.

Subsequently, the reason why the areas of the deodorizing filter bodies 731 and 732 are different from each other will be described.

First, the one-pass deodorizing performance test performed by the present inventors will be described.

The present inventors prepared a first test specimen having the same configuration as the first deodorizing filter body 731 and a second test specimen having the same configuration as the second deodorizing filter body 732. Herein, the areas of the first and second test specimens are equal, and the pressure losses across the first and second test specimens are equal, and the thickness of each test specimen is 10 mm.

Next, the present inventors had air containing acetaldehyde, acetic acid and ammonia with a predetermined concentration (specifically, about 5 ppm to 10 ppm) pass through each of the first and second test specimens at a predetermined wind speed (specifically, 1 m/sec) only one time. Then, before and after passing through each test specimen, the concentration of each odor component contained in air was measured, and the removal rate of each odor component was obtained based on the measured value.

Table 1 below shows the removal rate of acetaldehyde and acetic acid, the removal rate of ammonia, and the ratio of the removal rate thereof.

ODOR COMPONENT

| | ACETALDEHYDE | |
|---|---|---|
| | ACETIC ACID | AMMONIA |
| REMOVAL RATE | 50% | 75% |
| RATIO OF | 2:3 | |
| REMOVAL RATE | | |
| TEST SPECIMEN | FIRST | SECOND |

As illustrated in Table 1, the removal rate of acetaldehyde and acetic acid is 50%. The removal rate of ammonia is 75%. In other words, whereas ammonia contained in air is removed 75% by only one pass through the deodorizing filter 112, acetaldehyde and acetic acid are removed no more than 50%. That is, the ratio of the removal rate of acetaldehyde and acetic acid to the removal rate of ammonia is 2:3.

As a result of the above test, it can be seen that the air purifier 1 which includes the deodorizing filter 112 employing the first and second test specimens cannot uniformly remove three types of odor components.

Next, the reason why the area of the first deodorizing filter body 731 is 1.5 times that of the second deodorizing filter body 732 will be described.

Herein, the area ratio of the deodorizing filter bodies 731 and 732 is the inverse number of the ratio of the removal rate in the one-pass deodorizing performance test. In other words, the magnitude relation between the areas of the deodorizing filter bodies 731 and 732 is inverse to the magnitude relation between the removal rates thereof.

It is difficult for the first deodorizing filter body 731 to remove acetaldehyde and acetic acid, but the area is large. On the other hand, it is easy for the second deodorizing filter body 732 to remove ammonia, but the area is small. That is, it is easy for the air passing through the deodorizing filter 112 to be in contact with the first deodorizing filter body 731 and difficult to be in contact with the deodorizing filter body 732.

Consequently, it can be considered that the removal rate of acetaldehyde and acetic acid and the removal rate of ammonia become the same when the one-pass deodorizing performance test was performed using the air purifier 1 including the deodorizing filter 112 of the present embodiment. That is, it can be considered that the ratio of the removal rate thereof is 1:1.

As a result of the above description, the air purifier 1 including the deodorizing filter 112 of the present embodiment may remove three types of odor components uniformly.

Herein, the reason for differently configuring the area of the deodorizing filter bodies 731 and 732 is to more improve the air purification capability of the air purifier 1.

### Embodiment 4

An air purifier 1 of the present embodiment has the same configuration with the air purifier 1 of the Embodiments 1 to 3 except the configuration of a deodorizing filter 112. Hereinafter, the deodorizing filter 112 of the present embodiment will be described, and the other parts corresponding to the Embodiment 1 will be denoted by the same reference numerals, and a detailed description thereof will be omitted.

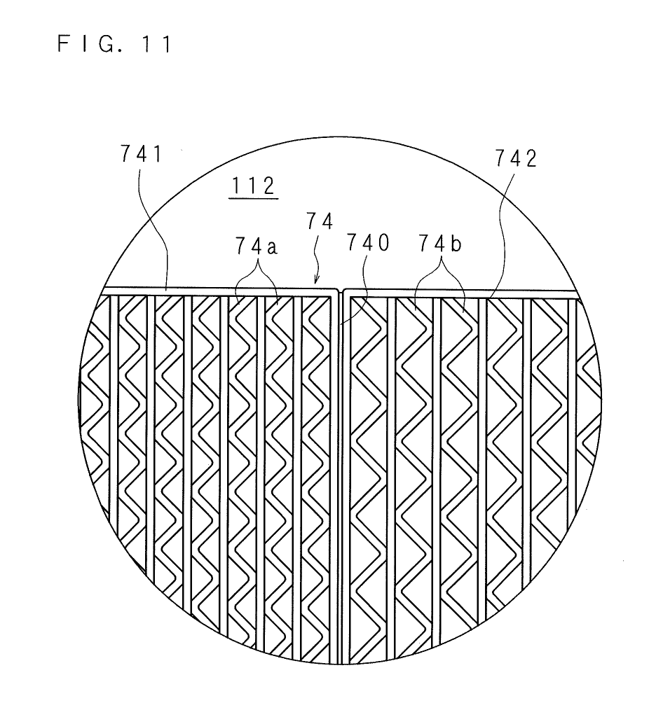

FIG. 11 is a rear view illustrating the configuration of the deodorizing filter 112 according to Embodiment 4 of the present invention. FIG. 11 corresponds to FIG. 5 of Embodiment 1.

The deodorizing filter 112 illustrated in FIG. 11 includes a body part 74 instead of the body parts 71 to 73 of Embodiments 1 to 3.

The body part 74 includes two pieces of deodorizing filter bodies 741 and 742, each of which has a rectangular shape. Each of the deodorizing filter bodies 741 and 742 has a honeycomb structure of a corrugated shape. The height, width, and thickness D of the deodorizing filter bodies 741 and 742 are equal.

The body part 74 is configured by juxtaposing the deodorizing filter bodies 741 and 742 on the left and right in the plane direction. Specifically, the left half of the body part 74 includes a first deodorizing filter body 741, and the right half of the body part 74 includes a second deodorizing filter body 742. The right side portion of the first deodorizing filter body 741 and the left side portion of the second deodorizing filter body 742 are bonded through an adhesive layer 740.

The pressure loss across the first deodorizing filter body 741 is 15 Pa, and the pressure loss across the second deodorizing filter body 742 is 10 Pa. Accordingly, the ratio of the pressure loss across the deodorizing filter bodies 741 and 742 is 3:2.

Herein, a difference in the pressure loss across the deodorizing filter bodies 741 and 742 will be described.

Pitches of respective flutes 74a included in the first deodorizing filter body 741 are smaller than the pitches of respective flutes 74b included in the second deodorizing filter body 742. Accordingly, an opening area of the first deodorizing filter body 741 is smaller than an opening area of the second deodorizing filter body 742. In other words, the first deodorizing filter body 741 has a fine filter mesh size compared with the second deodorizing filter body 742. As a result, the difference in the pressure loss across the deodorizing filter bodies 741 and 742 occurs.

Next, the reason why the pressure losses of the deodorizing filter bodies 741 and 742 are different from each other will be described.

Herein, the one-pass deodorizing performance test performed by the present inventors will be described.

The present inventors prepared a third test specimen having the same configuration with the first deodorizing filter body 741 and a fourth test specimen having the same configuration with the second deodorizing filter body 742. Herein, the areas of the third and fourth test specimens are equal, and the pressure losses across the third and fourth test specimens are equal, and the thickness of each test specimen is 10 mm.

Next, the present inventors had air containing acetaldehyde, acetic acid and ammonia with a predetermined concentration pass through each of third and fourth test specimens at a predetermined wind speed only one time. Then, before and after passing through each test specimen, the concentration of each odor component contained in air was measured, and the removal rate of each odor component was obtained based on the measured value. As a result, it can be seen that the ratio of the removal rate of acetaldehyde and acetic acid to the removal rate of ammonia is 2:3.

As a result of the above test, it can see that the air purifier 1 which includes the deodorizing filter 112 employing the third and fourth test specimens cannot uniformly remove three types of odor components.

Meanwhile, in the deodorizing filter 112 of the present embodiment, the ratio of the pressure loss across the deodorizing filter bodies 741 and 742 is the inverse number of the ratio of the removal rate thereof. In other words, the magnitude relation of the pressure loss across the deodorizing filter bodies 741 and 742 is the inverse of the magnitude relation of the removal rate thereof.

It is difficult for the first deodorizing filter body 741 to remove acetaldehyde and acetic acid, but the wind speed at which air passes through the first deodorizing filter body 741 is low. That is, air comes into contact with the first deodorizing filter body 741 for a long time. On the other hand, it is easy for the second deodorizing filter body 742 to remove ammonia, but the wind speed at which air passes through the second deodorizing filter body 742 is high. That is, air comes into contact with the second deodorizing filter body 742 only for a short time.

Consequently, the removal rate of acetaldehyde and acetic acid and the removal rate of ammonia become the same when the one-pass deodorizing performance test was performed using the air purifier 1 including the deodorizing filter 112 of the present embodiment. That is, the ratio of the removal rate thereof is 1:1.

As a result of the above, the air purifier 1 including the deodorizing filter 112 of the present embodiment may remove three types of odor components uniformly.

Herein, the reason for differently configuring the pressure loss across the deodorizing filter bodies 741 and 742 is to more improve the air purification capability of the air purifier 1.

In this regard, a method for varying the pressure loss across the deodorizing filter bodies 741 and 742 is not limited to the method of varying the pitches of the pitch flutes 74a and 74b.

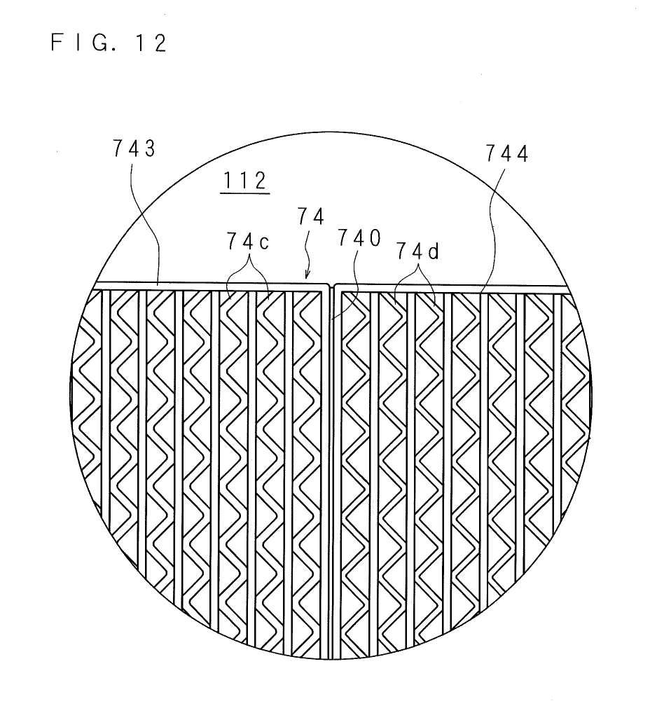

FIG. 12 is a rear view illustrating another configuration of the deodorizing filter 112 according to Embodiment 4 of the present invention. FIG. 12 corresponds to FIG. 11.

Also, in the body part 74 illustrated in FIG. 12, an opening area of a first deodorizing filter body 743 is appropriately smaller than an opening area of a second deodorizing filter body 744. Therefore, in the body part 74, the thickness of the respective flutes 74c included in the first deodorizing filter body 743 is appropriately larger than the thickness of the respective flutes 74d included in the second deodorizing filter body 744. As a result, the ratio of the pressure loss across the deodorizing filter bodies 743 and 744 is 3:2.

That is, it is possible to vary the pressure loss across the deodorizing filter bodies 743 and 744, by varying the thickness of the respective flutes 74c and 74d.

Moreover, the respective thicknesses of the plurality of deodorizing filter bodies included in the deodorizing filter 112 may not be the same. For example, the thickness of the deodorizing filter body for which it is difficult to remove odor components may be greater than that of the deodorizing filter body for which it is easy to remove odor components.

In addition, the air purification capability of each deodorizing filter body included in the deodorizing filter 112 is not to be limited to the capability capable of mainly removing aldehyde-based odor components or the capability capable of mainly removing amine-based odor components. For example, the air purification capability of each deodorizing filter body may be a capability capable of mainly removing organic acid-based odor components (for example, acetic acid), a capability capable of mainly removing sulfur-based odor components (for example, methylmercaptan), a capability capable of mainly removing indole-based odor components (for example, indole) or the like.

The air purification capability of the deodorizing filter 112 is not limited to two types but may be of three or more types. In this case, the first deodorizing filter body that mainly removes aldehyde-based odor components, the second deodorizing filter body that mainly removes amine-based odor components, and the third deodorizing filter body that mainly removes sulfur-based odor components, and . . . are juxtaposed in the plane direction to be joined one another, for example.

By the way, a conventional air purifier in the art is not provided with the second ventilation passage 4. Further, the ion generator 12 may be disposed near the first blowout port 32. Even with such a configuration, the effects of the present invention may be obtained by providing the deodorizing filter 112 as described in Embodiments 1 to 4.

The deodorizing filter 112 as described in Embodiments 1 to 4 functions as a filter according to the embodiments of the present invention, and the deodorizing filter bodies 711 to 716, 721 to 724, 731, 732, and 741 to 744 function as a filter body.

### Embodiment 5

In Embodiments 1 to 4, the air purifier according to the present invention, that is, the air purifier including the filter according to the present invention, has been described.

However, the filter of the present invention is not limited to the configuration provided in the air purifier, but may have the configuration that can be provided in the air conditioner described in Japanese Patent Application Laid-open No. 2008-32387, for example, the electric cleaner described in Japanese Patent Application Laid-open No. 2003-153831 or the like. That is, the filter of the present invention may be applied to various types of apparatuses configured in such a way that air passes through the filter during blowing or exhausting air by the blower.

Hereinafter, an embodiment of a garbage disposer including the filter according to the present invention will be described.

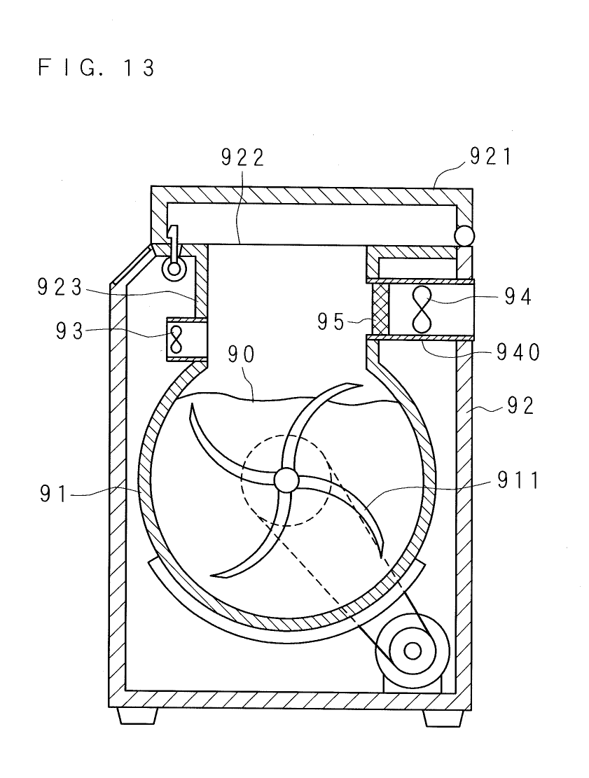

FIG. 13 is a cross-sectional side view schematically illustrating major parts of the garbage disposer including a deodorizing filter according to Embodiment 5 of the present invention.

The garbage disposer includes a treating tank 91 which is housed in a housing 92. The housing 92 includes a garbage inlet port 922 which is formed on a top thereof to be openably/closably covered by an upper lid 921. The garbage inlet port 922 is communicated to an upper portion of the treating tank 91 through an inlet chute 923 extending downward therefrom.

The treating tank 91 includes a bio base material 90 which is housed therein so as to provide live aerobic microorganisms having the capacity of decomposing organic materials. In addition, an agitator 911 is disposed in the treating tank 91. When garbage is inputted into the garbage inlet port 922, the garbage falls on the bio base material 90, and is absorbed into the bio base material 90 while being agitated by the agitator 911, so that the garbage is decomposed by the activity of the microorganisms.

An air supply fan 93 is mounted on a front side of the inlet chute 923. When the air supply fan 93 is driven, outer air is supplied into the treating tank 91.

The rear side of the inlet chute 923 is communicated to the outside of the housing 92 through an exhaust duct 940. An exhaust fan 94 having a discharge side to be arranged outside of the housing 92 is disposed in the middle of the exhaust duct 940.

A deodorizing filter 95 is mounted in an intake port of the exhaust duct 940 in an orientation crossing to a ventilation direction of air flowing through the exhaust duct 940. The deodorizing filter 95 is constituted by juxtaposing two deodorizing filter bodies in the plane direction, like the deodorizing filter 112 of Embodiment 1, for example.

One of the two deodorizing filter bodies has an air purification capability of neutralizing acidic gas accompanying acid odors such as hydrogen sulfide odor or acetic acid odor, and the other has an air purification capability of neutralizing alkaline gas accompanying alkaline odors such as ammonia odor or trimethylamine odor.

Such a deodorizing filter 95 functions as the filter according to the embodiment of the present invention.

When the exhaust fan 94 is driven, gas is sucked from the treating tank 91 through the inlet chute 923 and the exhaust duct 940, passed through the deodorizing filter 95, and then blown to the outside of the housing 92.

As a result of the above, it is possible to prevent bad odor generated in the treating tank 91 from leaking out together with the exhaust gas.

The deodorizing filter 95 has two types of air purification capabilities with reduced pressure loss and filter space. Therefore, the garbage disposer including the deodorizing filter 95 has a compact configuration that exerts two types of air purification capabilities.

Moreover, the filter of the present invention is not limited to the deodorizing filters 112 and 95. For example, the filter of the present invention may be a filter in which the deodorizing filter body and the dust collecting filter body are juxtaposed in the plane direction.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

In addition, the deodorizing filters 112 and 95 and the air purifier 1 may include a component which is not disclosed in Embodiments 1 to 5, in so far as to exert the effects of the present invention.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-7. (canceled)

8. A filter comprising:
a plurality of pieces of filter bodies configured to purify air passing therethrough,
wherein at least two filter bodies have different air purification capabilities, and
the plurality of pieces of filter bodies are juxtaposed in a plane direction thereof.

9. The filter according to claim 8,
wherein the plurality of pieces of filter bodies having different air purification capabilities are configured to be different in odor components mainly removed by respective filter bodies.

10. The filter according to claim 9,
wherein one filter body of the plurality of pieces of filter bodies having different air purification capabilities is made of cellulose and silica gel, and the other filter body thereof is made of cellulose and activated charcoal.

11. The filter according to claim 9,
wherein a magnitude relation between an area of one filter body configured to mainly remove one odor component and an area of the other filter body configured to mainly remove the other odor component different from the one odor component is inverse to a magnitude relation between a removal rate at which the one odor component is removed by the one filter body and a removal rate at which the other odor component is removed by the other filter body when the respective areas are equal.

12. The filter according to claim 9,
wherein a magnitude relation between a pressure loss across one filter body configured to mainly remove one odor component and a pressure loss across the other filter body configured to mainly remove the other odor component different from the one odor component is inverse to a magnitude relation between a removal rate at which the one odor component is removed by the one filter body and a removal rate at which the other odor component is removed by the other filter body when the respective pressure losses are equal.

13. An air purifier comprising:
a filter which includes a plurality of pieces of filter bodies configured to purify air passing therethrough;
a blower; and
a ventilation passage configured to suck air from an outside thereof by blowing air by the blower and blow out the sucked air to the outside thereof after being passed through the filter,
wherein the filter is the filter according to claim 8, and
the filter is disposed in an orientation crossing to a ventilation direction of the air flowing through the ventilation passage.

14. The air purifier according to claim 13,
wherein the ventilation direction is a lateral direction, and
the plurality of pieces of filter bodies are configured in such a way that ranges having the same air purification capabilities are disposed to be symmetric in a vertical direction or point-symmetric with respect to a central point of the plurality of pieces of filter bodies.
